(19) United States
(12) Patent Application Publication
(10) Pub. No.: US 2013/0307239 A1
(43) Pub. Date: Nov. 21, 2013

(54) Shopping Cart and Method of Assembling Same

(71) Applicants: Woody Smith, Stillwater, OK (US); Wesley McMurtrey, Wagoner, OK (US)

(72) Inventors: Woody Smith, Stillwater, OK (US); Wesley McMurtrey, Wagoner, OK (US)

(73) Assignee: UNARCO INDUSTRIES, LLC, Wagoner, OK (US)

(21) Appl. No.: 13/537,963

(22) Filed: Jun. 29, 2012

Related U.S. Application Data
(60) Provisional application No. 61/648,973, filed on May 18, 2012.

(51) Int. Cl. B62B 3/08; B21F 15/00; B23P 11/00

(52) U.S. Cl. 280/47.34; 29/428; 29/505

(57) ABSTRACT

A shopping cart comprised of separate basket and frame portions is assembled at the point of use without welding or special tools by a mechanical engagement of basket portion rim wires into clips. The method of assembling the cart includes orienting the basket with its rim wires relative to the frame and its clips such that the rim wires can be placed into a rear clip, rotated to lock the rim wires into the rear clip and rotated further to latch the rim wires to a front clip.

### BACKGROUND

Shopping carts, which are comprised of a wheeled frame to which a wire-mesh basket is affixed, are relatively light but nevertheless bulky. While they are designed to be telescoped together, i.e., placing the front end of the basket into a movable rear panel, wire-mesh shopping carts are relatively difficult to economically package and ship in their assembled state. A method and apparatus for facilitating the shipment of frame and basket portions in a disassembled state and which allows the separate portions to be assembled at their point of use, would be an improvement over the prior art.

### BRIEF DESCRIPTION OF THE FIGURES

FIG. 1 is a perspective view of a shopping cart assembly;

FIG. 2 is an isolated perspective view of the shopping cart assembly;

FIG. 3 is an isolated view of the spring wire attached to a rim wire by two welds;

FIG. 4 is a top view of the spring wire lying in a horizontal plane and showing how the spring wire, with an included loop or detent, is oriented when it is attached to a rim wire;

FIG. 5A and FIGS. 5B and 5C are top views of a spring wire having a rim wire attached below the spring wire and showing the action of the two wires relative to each other as they are driven onto a wire spade connector;

FIG. 6 is a depiction of the frame portion showing the spade connector formed on the opposing ends of a relatively stiff heavy gauge generally U-shaped wire connecting rod;

FIG. 7 shows a basket portion attached to a frame portion using the aforementioned two-wire trap;

FIG. 8 is a perspective view of the spade connector; and

FIG. 9 is a typical stress-strain curve.

### DETAILED DESCRIPTION

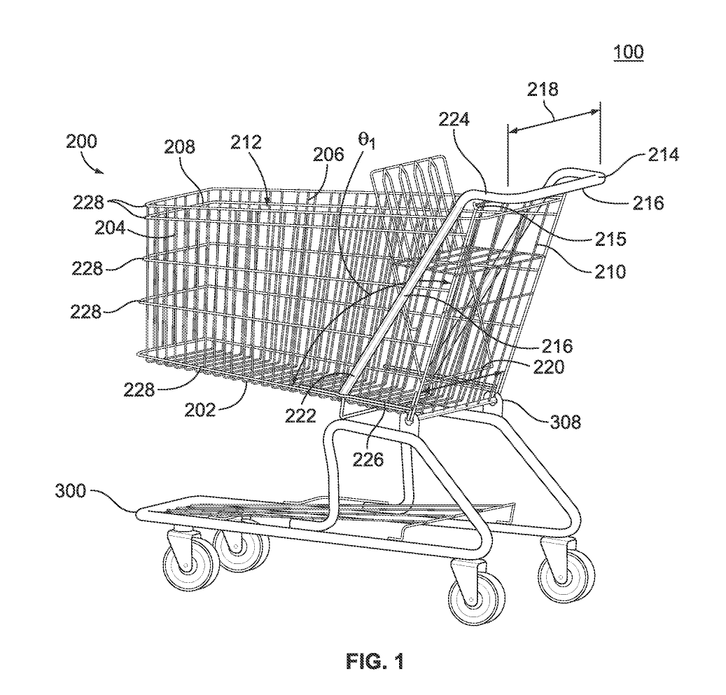

FIG. 1 is a perspective view of a shopping cart assembly 100. The shopping cart assembly 100 is comprised of a wire basket portion 200 and a frame portion 300. The basket portion 200, which is also referred to herein simply as “the basket” has a wire-mesh bottom 202 and two opposing wire-mesh sides or sidewalls 204 and 206. A wire-mesh front end 208 and a wire-mesh inclined back end 210 define a wire-mesh basket with an open top 212. The wire-mesh inclined back end 210 is able to flip up, i.e., rotate inwardly, around a hinge-like connection 215 located in front of the horizontal handle portion 214. Relatively heavy-gauge wires denominated herein as “rim” wires 228 are stiff and provide strength to the sidewalls 204 and 206 and the bottom 202.

The basket portion handle 214 is comprised of an elongated length of relatively large-diameter tubing or tube 216 bent or otherwise formed to provide a horizontal user portion 214 having a width 218 that is slightly larger than the overall width 220 of the inclined back end 210. Two sloping or inclined handle extensions 222 extend downwardly from two, horizontal and forwardly-extending handle portions 224 to where the angled handle extensions 222 meet and are attached to a rim wire-reinforcing spring wire 226. The inclined portions 222 are shown as being inclined at an angle θ (theta) relative to the bottom 202. The inclined handle portions 222 have bottom ends 223 that are attached to substantially horizontal spring wires 226.

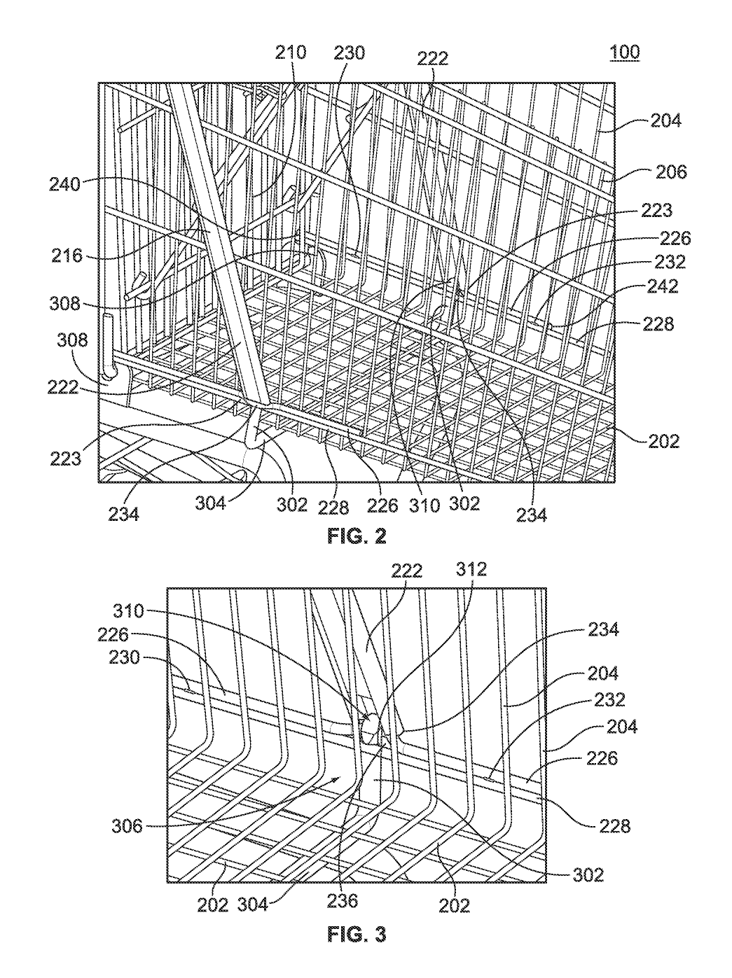

FIG. 2 is a perspective view of the shopping cart assembly 100 but showing an isolated portion of the inclined handle member 222. As stated above, the inclined handle member 222 is formed from an elongated tube 216 that also forms the handle 214 shown in FIG. 1. The bottom end 223 of the inclined handle portion or member 222 of the elongated tube 216 is fixedly attached to a horizontally-oriented spring wire 226 preferably by welding. The horizontal-oriented spring wire 226 is so named because the spring wire 226 extends away from the bottom end 223 of the inclined handle member 222 substantially horizontal to a surface on which the basket assembly is used and because the spring wire 226 acts as a spring, when it is attached to a basket rim wire 228, which is also considered to be horizontal or at least substantially horizontal.

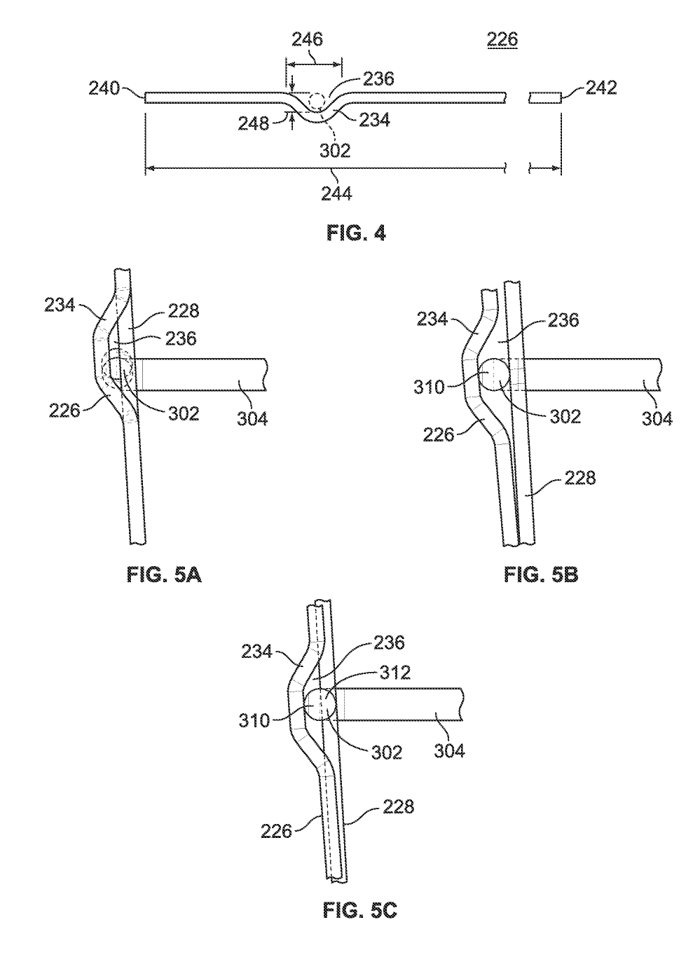

In a preferred embodiment, the horizontal spring wire 226 is solid with a circular or substantially-circular cross section, an overall length of between about six and twenty inches. Two opposing ends of the horizontal spring wire 226 are identified by reference numerals 240 and 242. (See FIG. 2 and FIG. 4.) In an alternate embodiment, the spring wire 226 can be hollow. In other embodiments, it can have cross-sectional shapes that are square, rectangular, triangular, oval or elliptical. For purposes of claim construction, the term, spring wire should be construed to include such other embodiments.

The spring wire 226 is attached to the rim wire 228 at or near locations that are near or proximate to the two ends 240, 242. The spring wire's attachment points are identified in FIG. 2 by reference numerals 230 and 232. They are preferably welds or “weldments” and are referred to herein after as the horizontal spring wire attachment points 230 and 232. In one embodiment (not shown), the attachment points 230 and 232 are co-located at the two ends 240 and 242 of the spring wire 226. The material from which the spring wire 226 is made, its cross sectional shape and the space or separation distance between the attachment points 230 and 232 determines the stiffness provided by the spring wire 226 relative to the rim wire 228 to which it is attached.

As described more fully below and in the applicant's co-pending patent application entitled “Basket-to-Frame Locking Clip,” which was filed 29 Mar. 2012, and having Ser. No. 13/433,928, and which is incorporated herein by reference in its entirety, the basket portion 200 and the frame portion 300 are “snapped” together using clips. The rear clips 308 enable the basket portion 200 to be attached to the frame portion 300 without tools. Increasing the stiffness of a rim wire that is “clipped” to a front-located basket-to-frame locking clip through a connector will increase the strength and ruggedness of the basket after the basket portion and frame portions are snapped together.

When the horizontal spring wire 226 is attached to a rim wire 228, it and the portion of the rim wire 228 that it is connected to, act together as a spring-like clip or two-wire “trap” for a basket-to-frame locking clip, such as the wire spade 302 shown in the figures or the clip disclosed in the aforementioned co-pending '928 application. The horizontal spring wire 226 also imbues an associated rim wire 228, i.e., a rim wire 228 to which the spring wire 226 is attached, a significantly increased stiffness along the length of the rim wire 228 to which the spring wire 226 is attached. The spring wire 226 in combination with the rim wire 228 thus provides both a spring-like clip and localized increased stiffness to the rim wire 228, i.e., an increased stiffness localized to where the spring wire 226 is attached, increasing or improving an assembled basket 100 ruggedness. The spring wire 226 obviates the need to manufacture the basket portion 200 with a horizontal rim wire 228 that would otherwise need to be much larger in diameter. The spring wire 226 thus enables the basket portion 200 to be lighter and less costly to manufacture.

FIG. 3 is a more isolated view of the spring wire 226 showing its attachment to the rim wire 228 by a first weldment or weld joint 230 located near the first end 240 of the spring wire 226 and just in front of the back or rear end 210 of the basket portion 200. A second attachment or weldment is located near the opposite, second end 242 of the spring wire 226. The spaced-apart attachment points of the spring wire 226 to the rim wire 228 thus leaves an “intermediate” portion of the spring wire 226, i.e., the spring wire portion between the joints 230 and 232, unconnected or “free” to move laterally or “sideways” relative to the rim wire 228 that is also between the two weldments 230 and 232. The portion of the spring wire 226 and the portion of the rim wire 228 between the two joints 230, 232 are both able to deflect, relative to each other. The assembly also comprises a wire basket attachment spade 302 having a chamfered top end 310 and a slot 312 (See FIGS. 4, 7 and 8.) into which the rim wire 228 can be held. The two wires 226, 228 thus form a trap for the spade 302.

FIG. 4 is a top view of the spring wire 226 shown lying in a horizontal plane and showing how the spring wire 226 is oriented when it is attached to a rim wire 228. The spring wire 226 has a first end 240 and an opposing second end 242. The space between them defines the length 244 of the spring wire, which is preferably about 12-14 inches but can be as short as 6-8 inches or as long as the side 204, 206 of the wire basket portion 200.

A U-shaped “detent” portion 234 is formed approximately midway between the two ends 240 and 242. In a preferred embodiment, the U-shaped detent 234 has a width 246 and a depth 248 selected such that when the spring wire 226 is attached to a rim wire, the assembly of the spring wire 226 to a straight rim wire 228 forms a hole 236 (as shown in FIG. 4) into which the spade 302 can be forcibly fit, causing the two wires to deflect outwardly from each other. Stated another way, in a preferred embodiment, the spade 302 has an outside diameter too big to freely slide into and through the “hole” 236 formed by the U-shaped detent 234 and a rim wire to which the spring wire 226 would be attached. Forcibly driving the combination spring wire 226 and rim wire 228 downwardly over the upright-oriented spade 302, as will happen when the basket portion 200 is attached to two, rear-located clips 308 (as shown in FIG. 2) and rotated toward the spade 302, will cause the two wires 226 and 228 to deflect outwardly from each other. Their elasticity will cause them to “trap” or engage the spade 302 and force the rim wire 228 of the basket portion 200 into the slot 312 as shown in FIG. 3.

FIG. 5A and FIGS. 5B and 5C are top views of a spring wire 226 having a rim wire 228 attached below the spring wire 226. The U-shaped detent 234 projects outwardly and away from the rim wire 228 to define a hole 236. A portion of the top of the spade 302 can be seen in FIG. 5A as being located beneath the two wires 226, 228. Stated another way, in FIG. 5A, the two joined-together wires 226 and 228 are at rest atop the spade 302.

FIG. 5B shows the two wires being deflected away from each other as the two wires 226, 228 are driven over the chamfered top 310 of the spade 302, which happens when the basket portion 200 of the basket assembly 100 is being attached to the frame portion 300 using the process described in the aforementioned co-pending patent applications. The chamfered top 310 and the spade 302 thus act to provide a wire-separating force that is applied to both wires, which separates the wires 226 and 228 from each other as the chamfer 310 and wires 226, 228 are driven past each other. Wedge-shaped openings can be seen between the two wires 226 and 228 due to the outward deflection of the two wires 226, 228.

FIG. 5C shows the two wires 226, 228 after the rim wire 228 snaps into and is captured by a notch 312 formed into the spade 302. The two wires 226, 228 are considered to have trapped the rim wire 228 into the notch 312 in the spade 302, or vice versa.

The spring wire 226 is preferably attached to the rim wire 228 by welding because welding is relatively fast, durable and inexpensive. The spring wire 226 can be made of a spring steel, however, spring steel tends to anneal when subjected to high temperatures, especially those common to welding. A low carbon steel is therefore preferred because of its lower cost as compared to spring steels and because it is generally easier to weld than spring steels. The physical characteristics of the spring wire 226 are chosen so that the spring wire 226 deflection relative to the rim wire 228 during assembly of the basket portion 200 to the frame portion 300 is well within the linear portion of both of the wires' stress-strain curves. See FIG. 9.

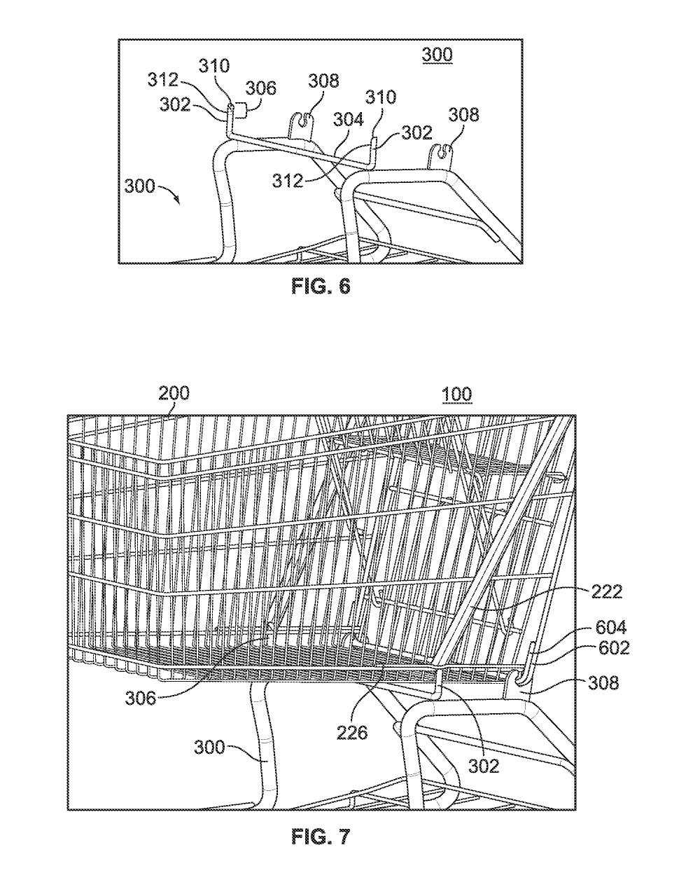

FIG. 6 is a depiction of the frame portion 300 but also showing the spade connectors 302 formed on the opposing ends of a relatively stiff heavy gauge generally U-shaped wire connecting rod 304. The spade portion 302 is provided with a basket-to-frame locking clip 306 as described in the applicant's co-pending application Ser. No. 13/433,928 entitled “Basket-to-Frame Locking Clip” filed Mar. 29, 2012, the entire content of which is incorporated herein by reference. A rear basket-to-frame locking clip 308 described in the applicant's co-pending patent application Ser. No. t.ba., incorporated herein by reference, is also shown.

Referring now to FIG. 7, a basket portion 200 is attached to a frame portion 300 using the aforementioned wire clips 306 and 308. When the basket portion is to be attached to the frame portion, two rear-located rim wires 602 and 604 are placed into the rear basket-to-frame locking clip 308 as described in the aforementioned patent application Ser. No. ( ). The rim wires 602 and 604 can be rotated as described in the (tba) application until the downwardly and inclined handle portion 222 attached to the spring wire 226 meets the upright-standing spade portion 302. A downward force on the basket portion drives the rim wire 228 over an inclined chamfer 310 on the upright spade portion 302 until the rim wire 228 and spring wire 226 separate from each other to allow the spade 302 to slide between them. The rim wire 228 and spring wire 226 are forced downwardly over and past the chamfer 310 of the spade 302 until the rim wire 228 latches into the notch 312 effectively locking the rim wire 228 into the spade 302 by virtue of the additional stiffness provided by the spring wire 226 and the clamping force provided to the spade 302 by the wires' rigidities. As shown in FIG. 4, the detent 234 receives the spade portion 302 at the same time the spring wire 226 maintains the rim wire 228 in a relatively straight and latched condition inside the spade 302.

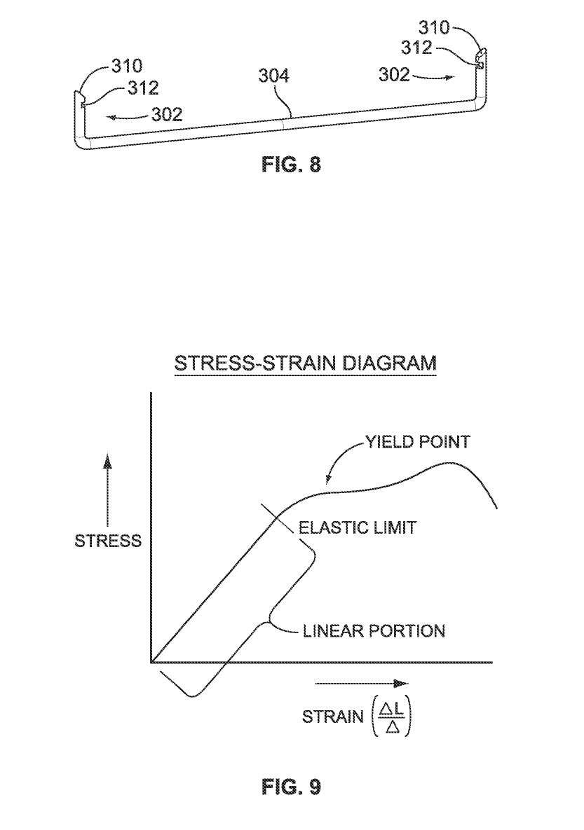

FIG. 8 shows details of the wire basket attachment spade 302. The long, straight portion is the wire connecting rod 304. The slots 312 on the sides of both spades 302 are located below the chamfers 310. The chamfers 310 allow or facilitate the spade's insertion into the holes 236 between the spring wires 226 and the rim wires 228. The slots 312 formed in the spades 302, which are attached to the frame portion 300, lock the basket portion 200 to the frame portion 300.

The foregoing description is purposes of illustration only. The true scope of the invention is set forth in the appurtenant claims.

What is claimed is:

1. A shopping cart comprising:
a frame comprised of a frame tube, the frame tube having a front portion and a rear portion;
a basket comprised of a wire mesh and first and second rim wires;
a rear clip configured to receive the first and second rim wires and to lock the rim wires and rear portion of the frame tube to each other, by engagement of the first and second rim wires and a subsequent rotation of the basket relative to the frame;
a front clip configured to receive a rim wire and lock the rim wire to the front portion of the frame, after the rear clip has received the first and second rim wires and after the basket has been rotated relative to the frame.

2. The shopping cart of claim 1, wherein the front and rear clips are sized, shaped and arranged to attach the basket to the frame by: 1) engagement of the rear clip to joined-together sections of the first and second rim wires; 2) a rotation of the basket relative to the frame; and 3) engagement of a rim wire to the front clip by further rotation of the basket relative to the frame.

3. The shopping cart of claim 1, wherein the rear clip is attached to a rear portion of the frame tube.

4. The shopping cart of claim 2, wherein the front clip is attached to a front portion of the frame tube.

5. The shopping cart of claim 1, wherein the rear clip is comprised of a substantially C-shaped body having a slot-like opening that extends through the body of the rear clip to an open interior, the open interior having at least one wire rotation-limiting projection into the open interior.

6. The shopping cart of claim 5, wherein the open interior of the rear clip has first and second wire rotation-limiting projections that extend into the open interior.

7. The shopping cart of claim 5, wherein each rim wire has a corresponding diameter, the first and second rim wires being joined to each other, lengthwise along a first portion of the two wires, combined diameters of the joined-together wires along the first portion defining a major dimension for the joined together wires along the joined-together portion, a largest diameter of the two wires defining a minor dimension of the two joined-together wires, wherein the slot-like opening has a width greater than the minor dimension but less than the major dimension, the open interior of the rear clip being large enough to allow the joined-together wires to rotate in the open interior through a limited angle.

8. The shopping cart of claim 4, wherein the front clip is comprised of a section of the first rim wire and a length of a third wire forming a spring wire, the section of the first rim wire and the spring wire forming a two-wire trap, the spring wire having first and second ends and being attached to the section of the first rim wire near the first and second ends.

9. The shopping cart of claim 8, wherein one wire of the two wire trap is comprised of a detent.

10. The shopping cart of claim 4, wherein the front clip is comprised of:
a clip body attached to the front portion of the frame;
a rim wire receiving notch formed into the body, the notch being comprised of an opening through a first side of the body, the opening facing laterally; and
a rim wire follower comprised of a surface extending outwardly from the first side of the body, the rim wire follower being configured to urge a substantially horizontal rim wire traveling over the surface to deflect sideways in a first lateral direction away from the first side and snap into the rim wire receiving notch.

11. A method of assembling a basket portion of a shopping cart to a frame portion of a shopping cart, the basket portion having a rear side and first and second rim wires which are joined-together along a length of the first and second rim wires that runs along the rear side of the basket portion, the frame portion having a rear clip configured to receive and capture the first and second rim wires along where they are joined together, the frame portion also having a front clip configured to capture the first rim wire, after the rear clip has received and captured joined together rim wires, the method of assembling the basket portion and frame portion comprising the steps of:
orienting the basket portion to the frame portion such that a major dimension of the joined-together rim wires aligns with a slot-like opening in the rear clip;
manipulating the basket portion relative to the frame portion in order to pass the joined-together rim wires through the slop-like opening in the rear clip and into an open interior in the rear clip;
after the joined-together wires are in the open interior of the rear clip, rotating the basket portion relative to the frame portion through a first angle at which a portion of the first rim wire contacts a portion of the front clip; and
continuing to rotate the basket portion relative to the frame portion through a second angle whereat the first rim wire is captured by the front clip and whereat the basket portion and frame portion are locked to each other by the rear clip and front clip.

12. The method of claim 11, wherein the rear clip is substantially C-shaped and comprised of a rim wire rotation-limiting projection into open interior of the rear clip and wherein the step of rotating the basket portion relative to the frame portion through a first angle is comprised of rotating the first and second joined-together rim wires after they are in the rear clip and relative to the rear clip such that at least one of the joined-together rim wires engages the rim wire rotation-limiting projection, which inhibits further rotation of the joined-together rim wires.

13. The method of claim 12, wherein the at least one joined-together rim wire engages the rim wire rotation-limiting projection, before rotation of the basket portion relative to the frame portion reaches the first angle.

14. The method of claim 12, wherein continued rotation of the basket portion relative to the frame portion, after the at least one rim wire engages a rim wire rotation-limiting projection, twists at least one rim wire in the rear clip.

15. The method of claim 12, wherein a continued rotation of the basket portion relative to the frame portion, after the at least one rim wire engages a rim wire rotation-limiting projection, bends the at least one rim wire.

16. The method of claim 12, wherein the front clip is comprised of:
a two-wire trap attached to the basket portion; and
a spade portion attached to the frame; and
wherein rotation of the basket portion relative to the frame portion from the first angle to the second angle drives the spade portion between two wires that comprise the two-wire trap.

17. The method of claim 16, wherein the spade portion is comprised of a slot and wherein driving the spade portion between the two wires latches one of the two wires into the slot.

18. The method of claim 16, wherein the two-wire trap is comprised of a detent in one of the wires, the detent forming a opening configured to receive the spade portion, and wherein the spade portion is comprised of a chamfered end, wherein the step of driving the spade causes the chamfered end of the spade portion to exert a wire separation force on both wires.

19. The method of claim 12, wherein the front clip is comprised of:
a clip body attached to the front portion of the frame;
a rim wire receiving notch formed into the body, the notch being comprised of an opening through a first side of the body, the opening facing laterally; and
a rim wire follower comprised of a surface extending outwardly from the first side of the body, the rim wire follower being configured to urge a substantially horizontal rim wire traveling over the surface to deflect sideways in a first lateral direction away from the first side and snap into the rim wire receiving notch; and
wherein rotation of the basket portion relative to the frame portion from the first angle to the second angle drives the first rim wire over the rim wire follower in a first lateral direction away from the first side and snaps the first rim wire into the rim wire receiving notch.
